(19) United States
(12) Patent Application Publication
(10) Pub. No.: US 2025/0201957 A1
(43) Pub. Date: Jun. 19, 2025

(54) SEPARATION RECOVERY METHOD OF METAL IONS AND ACIDIC METAL EXTRACTANT

(71) Applicant: FUJIFILM Corporation, Tokyo (JP)

(72) Inventors: Yo KUSHIDA, Kanagawa (JP); Hiroaki MOCHIZUKI, Kanagawa (JP)

(73) Assignee: FUJIFILM Corporation, Tokyo (JP)

(21) Appl. No.: 19/064,587

(22) Filed: Feb. 26, 2025

Related U.S. Application Data
(63) Continuation of application No. PCT/JP2023/033378, filed on Sep. 13, 2023.

(30) Foreign Application Priority Data
Sep. 15, 2022 (JP) 2022-147026

(51) Int. Cl. H01M 10/54; C22B 3/00; C22B 3/38

(52) U.S. Cl. CPC H01M 10/54; C22B 3/384; C22B 23/0461

(57) ABSTRACT

Provided are a separation recovery method of metal ions and an acidic metal extractant used in the separation recovery method. The separation recovery method includes: extracting and separating two or more kinds of metal ions belonging to different groups by mixing a water phase and an oil phase with each other, the water phase including two or more kinds of metal ions belonging to different groups among metal ions belonging to Groups 9 and 10 of the fourth to sixth periods in a periodic table, and the oil phase including an acidic metal extractant having two or more coordinating functional groups selected from a carboxy group, a phosphate group, a phosphonate group, a sulfonate group, and a sulfinate group.

### CROSS-REFERENCE TO RELATED APPLICATIONS

This application is a Continuation of PCT International Application No. PCT/JP2023/033378 filed on Sep. 13, 2023, which claims priority under 35 U.S.C. § 119 (a) to Japanese Patent Application No. 2022-147026 filed in Japan on Sep. 15, 2022. Each of the above applications is hereby expressly incorporated by reference, in its entirety, into the present application.

### BACKGROUND OF THE INVENTION

### 1. Field of the Invention

The present invention relates to a separation recovery method of metal ions in which metal ions present in a water phase are extracted to an oil phase, and an acidic metal extractant used in the separation recovery method.

### 2. Description of the Related Art

Metals that can be mined from mines are limited, and stable supply of noble metals required for precision equipment is a big challenge. Accordingly, it is important to recover valuable metals from industrial waste irrespective of mining.

In particular, along with the recent spread of electric vehicles, the amount of lithium ion batteries (LiB) wasted has been increasing every year. In LiB, a positive electrode active material including a metal element such as cobalt or nickel is used, and a significant increase in the demand for nickel is also expected. In order to deal with the increase in the demand for valuable metals along with the tidal current, not only an increase in the amount of mining but also a technique of recycling waste LiB into a metal are desired.

As a method of recycling waste into a metal, a wet extraction method (solvent extraction method) is used. In the wet extraction method, in a case where an aqueous solution (water phase) including ions of a metal element (simply referred to as metal ions) and an organic phase including a metal extractant are brought into contact with each other, mixed, and left to stand to separate the two phases, the metal ions to which the metal extractant is coordinated can be moved (extracted) to the organic phase. By extracting the organic phase, stripping the metal ions, and optionally purifying the metal ions, the waste can be recycled as a (high-purity) metal. As the wet extraction method using the metal extractant, for example, JP1984-084894A (JP-S59-084894A) describes a method of extracting U ions from a phosphoric acid aqueous solution including Fe ions, Ca ions, Al ions, and U ions using a phosphonate represented by specific Formula (I). In addition, JP1991-169887A (JP-H03-169887A) describes a method of extracting cobalt ions from a water layer including cobalt cycloalkanoate using a diphosphonate compound represented by specific Formula (I).

On the other hand, Journal of Organic Chemistry (2013), 78 (2), p. 270-277 describes that a compound represented by Expression: ROPS₂-CH₂-PS₂-OR (here, R represents methyl, butyl, benzyl, or the like) is coordinated to metal ions such as Hg (II), Pb (II), Zn (II), or Ca (II) to be useful as a metal extractant. In addition, Solvent Extraction and Ion Exchange (2006), 24 (3), p. 331-346 describes that P,P′-dialkylmethylenebisphosphonic acid is an effective metal extractant for lanthanide or an actinide element. Further, Separation Science and Technology (2005), 40 (1-3), p. 69-90 describes that P,P′-dialkylmethylenebisphosphonic acid is an effective metal extractant for lanthanoid or a trivalent actinide element (Am (III), Cm (III), Cf (III), or the like).

### SUMMARY OF THE INVENTION

JP1984-084894A (JP-S59-084894A) and JP1991-169887A (JP-H03-169887A describe that specific metal ions present in a water phase can be extracted and recovered to an oil phase. However, JP1984-084894A (JP-S59-084894A) merely describes a method of extracting and recovering U ions that are heavy metal ions in the coexistence of Fe ions, Ca ions, and Al ions. On the other hand, JP1991-169887A (JP-H03-169887A) merely describes a method of extracting and recovering cobalt ions that are one kind of metal ions present in a water phase. Further, Journal of Organic Chemistry (2013), 78 (2), p. 270-277, Solvent Extraction and Ion Exchange (2006), 24 (3), p. 331-346, and Separation Science and Technology (2005), 40 (1-3), p. 69-90 merely describes the extractant for the specific metal ions such as Hg (II) or actinide.

JP1984-084894A (JP-S59-084894A), JP1991-169887A (JP-H03-169887A), Journal of Organic Chemistry (2013), 78 (2), p. 270-277, Solvent Extraction and Ion Exchange (2006), 24 (3), p. 331-346, and Separation Science and Technology (2005), 40 (1-3), p. 69-90 do not consider a configuration of recovering one kind of metal ions with high selectivity and high recovery rate while extracting two or more kinds of metal ions belonging to different groups as ions of a valuable metal element among metal ions belonging to Groups 9 and 10 of the fourth to sixth periods in the periodic table. The reason for this is that, for example, needs for separating and recovering metal ions belonging to Groups 9 and 10 such as cobalt ions and nickel ions have rapidly increased due to recent rapid spread of lithium ion batteries, and it is not easy to separate and recover metal ions having similar physical behaviors and similar chemical behaviors in the related art. However, as long as one kind of metal ions can be recovered with high selectivity and high recovery rate while extracting metal ions (in particular, cobalt ions) belonging to Group 9 and metal ions (in particular, nickel ions) belonging to Group 10 having similar physical behaviors and similar chemical behaviors as ions of two or more kinds of valuable metal elements belonging to different groups among metal ions belonging to Groups 9 and 10 of the fourth to sixth periods, this configuration can largely contribute to further spread of electric vehicles and construction of a sustainable society.

An object of the present invention is to provide: a method of separating and recovering one kind of metal ions with high selectivity and high recovery rate while extracting two or more kinds of metal ions belonging to different groups among metal ions belonging to Groups 9 and 10 of the fourth to sixth periods from a water phase to an oil phase; and an acidic metal extractant used in this method.

The present inventors found that, in a wet extraction method of separating and recovering metal ions from a water phase including two or more kinds of metal ions belonging to different groups among metal ions belonging to Groups 9 and 10 of the fourth to sixth periods of the periodic table as ions of valuable metal elements, by mixing an oil phase including an acidic metal extractant having two or more coordinating functional groups selected from a group G1 of coordinating functional groups below with the water phase, while extracting two or more kinds of metal ions, particularly desirably, cobalt ions and nickel ions among the metal ions belonging to different groups from the water phase to the oil phase, one kind of metal ions can be extracted with high selectivity and high recovery rate.

The present invention has been completed as a result of repeated investigation based on the above findings.

That is, the above-described objects have been achieved by the following means.

<1> A separation recovery method of metal ions, the separation recovery method including:
extracting and separating two or more kinds of metal ions belonging to different groups by mixing a water phase and an oil phase with each other, the water phase including two or more kinds of metal ions belonging to different groups among metal ions belonging to Groups 9 and 10 of the fourth to sixth periods in a periodic table, and the oil phase including an acidic metal extractant having two or more coordinating functional groups selected from a group G1 of coordinating functional groups below,
<group G1 of coordinating functional groups>
a carboxy group, a phosphate group, a phosphonate group, a sulfonate group, and a sulfinate group.

<2> The separation recovery method according to <1>,
in which the acidic metal extractant is a phosphate compound.

<3> The separation recovery method according to <1> or <2>,
in which the acidic metal extractant is represented by Formula (I).

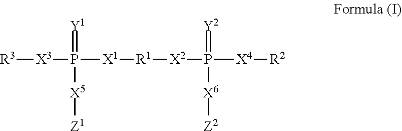

In Formula (I), R¹ represents an alkylene group, an alkenylene group, or an alkynylene group, which is substituted or unsubstituted,
R² and R³ each independently represent an alkyl group, an alkenyl group, or an alkynyl group, which is substituted or unsubstituted,
X¹ to X⁶ each independently represent a single bond, —O—, —NH—, or —S—,
Y¹ and Y² each independently represent an oxygen atom or a sulfur atom,
Z¹ and Z² each independently represent a hydrogen atom or a hydrocarbon group, and
at least one of Z¹ or Z² represents a hydrogen atom.

<4> The separation recovery method according to <3>,
in which R¹ represents an unsubstituted alkylene group.

<5> The separation recovery method according to any one of <1> to <4>,
in which the two or more kinds of metal ions belonging to different groups are cobalt ions and nickel ions.

<6> The separation recovery method according to <5>,
in which the two or more kinds of metal ions belonging to different groups are a metal recovery from a waste battery.

<7> An acidic metal extractant for extracting and separating two or more kinds of metal ions belonging to different groups among metal ions belonging to Groups 9 and 10 of the fourth to sixth periods in a periodic table in a wet extraction method,
in which the acidic metal extractant has two or more coordinating functional groups selected from a carboxy group, a phosphate group, a phosphonate group, a sulfonate group, and a sulfinate group.

<8> The acidic metal extractant according to <7>,
in which the two or more kinds of metal ions belonging to different groups are cobalt ions and nickel ions.

<9> The acidic metal extractant according to <7> or <8>, which is represented by Formula (I).

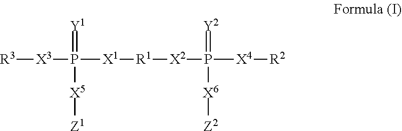

In Formula (I), R¹ represents an alkylene group, an alkenylene group, or an alkynylene group, which is substituted or unsubstituted,
R² and R³ each independently represent an alkyl group, an alkenyl group, or an alkynyl group, which is substituted or unsubstituted,
X¹ to X⁶ each independently represent a single bond, —O—, —NH—, or —S—,
Y¹ and Y² each independently represent an oxygen atom or a sulfur atom,
Z¹ and Z² each independently represent a hydrogen atom or a hydrocarbon group, and
at least one of Z¹ or Z² represents a hydrogen atom.

<10> The acidic metal extractant according to <9>, in which R¹ represents an unsubstituted alkylene group.

According to the present invention, it is possible to provide: a method of separating and recovering one kind of metal ions with high selectivity and high recovery rate while extracting two or more kinds of metal ions belonging to different groups among metal ions belonging to Groups 9 and 10 of the fourth to sixth periods from a water phase to an oil phase; and an acidic metal extractant used in this method.

The above-described and other characteristics and advantageous effects of the present invention will be clarified from the following description appropriately with reference to the accompanying drawings.

### BRIEF DESCRIPTION OF THE DRAWINGS

FIG. 1 is a ¹H-NMR chart showing a metal extractant E-2 synthesized in Example.

FIG. 2 is a ¹H-NMR chart showing a metal extractant E-3 synthesized in Example.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. In a case where a plurality of numerical ranges represented by “˜” are set and described, the upper limit value and the lower limit value which form each of the numerical ranges are not limited to a specific combination described before and after “to” as a specific numerical range and can be set to a numerical range obtained by appropriately combining the upper limit value and the lower limit value of each numerical range. In the present invention, numerical ranges represented by “to” include numerical values before and after “to” as lower limit values and upper limit values.

In the present invention, the expression of a compound (for example, in a case where a compound is represented by an expression with “compound” added to the end) refers to not only the compound itself but also a salt or an ion thereof. In addition, this expression also refers to a derivative obtained by modifying a part of the compound, for example, by introducing a substituent into the compound within a range where the effects of the present invention do not deteriorate.

A substituent, a linking group, or the like (hereinafter, referred to as “substituent or the like”) is not specified in the present invention regarding whether to be substituted or unsubstituted may have an appropriate substituent. Accordingly, even in a case where a YYY group is simply described in the present invention, this YYY group includes not only an aspect not having a substituent but also an aspect having a substituent. The same shall be applied to a compound which is not specified in the present specification regarding whether to be substituted or unsubstituted. Examples of a preferable substituent include groups selected from the substituent Z described below.

In the present invention, in a case where a plurality of substituents or the like represented by a specific reference numeral are present or a plurality of substituents or the like are simultaneously or alternatively defined, the respective substituents or the like may be the same as or different from each other. In addition, unless specified otherwise, in a case where a plurality of substituents or the like are adjacent to each other, the substituents may be linked or fused to each other to form a ring.

In the present invention, “metal ions belonging to Groups 9 and 10 of the fourth to sixth periods in the periodic table of elements”, that is, Co, Rh, and Ir (all of which are the Group 9 elements) and Ni, Pd, and Pt (all of which are the Group 10 elements) will be referred to as “specific metal ion group”.

In addition, “metal ions belonging to different groups in the periodic table of elements” in the specific metal ion group will be referred to as “different-group metal ions”, and particularly “different-group metal ions of the same period in the periodic table” will also be referred to as “same-period different-group metal ions”.

In the present invention, unless specified otherwise, “ppm” representing a content or the like is based on mass and represents “mass ppm”.

### [Acidic Metal Extractant]

First, an acidic metal extractant that is suitably used in a separation recovery method of metal ions according to an embodiment of the present invention (also referred to as the acidic metal extractant according to an embodiment of the present invention) will be described.

The acidic metal extractant according to the embodiment of the present invention is a compound having a function of extracting two or more kinds of different-group metal ions to an oil phase from the specific metal ion group present in a water phase, and can be suitably used particularly in a wet extraction method. By using the acidic metal extractant according to the embodiment of the present invention in the wet extraction method, while extracting two or more kinds of different-group metal ions, particularly desirably, cobalt ions and nickel ions that are the same-period different-group metal ions as ions of a valuable metal element from the specific metal ion group present in a water phase, one kind of metal ions can be extracted to an oil phase with high selectivity and high recovery rate.

In the present invention, being capable of extracting metal ions with high selectivity represents that specific metal ions can be extracted and separated from the other metal ions such that, among the two or more kinds of extracted different-group metal ions, a ratio of the amount of specific metal ions (typically one kind) to the total amount of the other metal ions extracted [(the amount of the specific metal ions extracted)/(the total amount of the other metal ions extracted) is 1.1 or more (resolution, selection ratio). The ratio is preferably 3.0 or more and more preferably 5.0 or more. The upper limit is not particularly limited and, in a case where two kinds of metal ions are extracted, can be, for example, 100.

In addition, in the present invention, being capable of extracting metal ions with high recovery rate represents that the metal ions can be extracted such that, regarding metal ions (specific metal ions to be extracted) extracted in the maximum amount the two or more kinds of extracted different-group metal ions, a ratio of the amount of the metal ion extracted to the oil phase to the content of the metal ions (before the extraction) in the water phase [(the amount of the metal ions extracted to the oil phase)/(the content of the metal ions in the water phase] is 0.5 or more. The ratio is preferably 0.8 or more and more preferably 0.9 or more. The upper limit is not particularly limited and is ideally the total amount of the metal ions present in the water phase. For example, the upper limit is preferably 0.99 or less and can also be 0.95 or less or 0.90 or less.

The acidic metal extractant according to the embodiment of the present invention is a compound (also referred to as the acidic metal extractant) having two or more coordinating functional groups selected from the group G1 of coordinating functional groups. That is, in the acidic metal extractant according to the embodiment of the present invention, the coordinating functional groups selected from the group G1 of coordinating functional groups includes at least one active hydrogen atom or a salt thereof.

From the viewpoint of solubility in the oil phase described below, it is preferable that the acidic metal extractant includes at least two hydrophobic groups. A linking group where coordinating functional groups are linked through a hydrophobic group, for example, a linking group or R¹ of Formula (I) may be included, but a coordinating functional group below (excluding a linking group linked to another coordinating functional group) is preferably included. The hydrophobic group is not particularly limited and is, for example, a hydrocarbon group. Examples of the hydrocarbon group include an alkyl group, an alkenyl group, or an alkynyl group that can be used as R² of Formula (I) described below and an aryl group. Among these, a long-chain alkyl group is preferable. The number of hydrophobic groups in the acidic metal extractant can be, for example, 2 to 6 and is preferably 2 to 4.

### <Group G1 of Coordinating Functional Groups>

a carboxy group, a phosphate group, a phosphonate group, a sulfonate group, and a sulfinate group.

The acidic metal extractant according to the embodiment of the present invention may be an aliphatic compound or an aromatic compound and is preferably an aliphatic compound. In addition, the acidic metal extractant according to the embodiment of the present invention may be a high-molecular-weight compound but is preferably a non-polymerizable low-molecular-weight compound.

In the acidic metal extractant according to the embodiment of the present invention, the linking group (a molecular structure where coordinating functional groups are removed) that links coordinating functional groups is not particularly limited, and an appropriate linking group can be selected. Examples of the linking group include a group derived from alkane, a group derived from alkene, a group derived from alkyne, a group derived from an aromatic compound (having preferably 6 to 24 carbon atoms and more preferably 6 to 10 carbon atoms), an oxygen atom, a sulfur atom, an imino group (—NR^{N}—: R^{N} represents a hydrogen atom, an alkyl group having 1 to 6 carbon atoms, or an aryl group having 6 to 10 carbon atoms), a carbonyl group, and a group including a combination thereof. As the linking group, a group derived from alkane, a group derived from alkene, a group derived from alkyne, a group derived from an aromatic compound, or a group including a combination thereof is preferable, a group derived from alkane, a group derived from alkene, a group derived from alkyne, or a group including a combination thereof is more preferable, and a group derived from alkane is still more preferable. As the linking group, a group corresponding to R¹ in Formula (I) described below is still more preferable.

Each of the group derived from alkane, the group derived from alkene, and the group derived alkyne may be a straight chain, a branched chain, or a cyclic chain but is preferably a straight chain, more preferably a straight chain, and still more preferably a straight chain where a coordinating functional group is bonded to both ends of the longest carbon chain.

The number of carbon atoms forming each of the group derived from alkane, the group derived from alkene, and the group derived alkyne is not particularly limited and is the same as the number of carbon atoms forming each of an alkylene group, an alkenylene group, and an alkynylene group that can be used as R¹ of Formula (I) described below. The number of carbon atoms forming a substituent in each of the groups is not added to the number of carbon atoms forming each of the groups.

In addition, in the group including the combination, the number of groups, linking groups, or atoms to be combined is not particularly limited and, for example, can be 2 to 20 and is preferably 2 to 10. In addition, the number of kinds of groups, linking groups, or atoms to be combined is not particularly limited and, for example, can be 2 or more and is preferably 2 or 3.

The linking group may include a substituent but preferably does not include a substituent. The substituent that may be included in the linking group is not particularly limited, and examples thereof include groups selected from a substituent Z described below and are the same as the substituents that may be included in R¹ of Formula (I) described below.

The number of linking atoms forming the linking group is preferably 1 to 10, more preferably 1 to 7, still more preferably 1 to 4, and still more preferably 1 or 3. The number of linking atoms refers to the minimum number of atoms that connect two coordinating functional groups. The number of atoms forming the linking group is not uniquely determined and can be appropriately set. For example, the number of atoms forming the linking group can be 3 to 30 and is preferably 3 to 20 and more preferably 3 to 10. For example, in a case where the linking group is —CH₂—CH₂—, the number of atoms forming the molecular structure is 6, and the number of linking atoms is 2.

In the present invention, in a case where the acidic metal extractant includes two or more linking groups, at least one linking group may be the above-described linking group, and it is preferable that all of the linking groups are the above-described linking groups.

In the acidic metal extractant according to the embodiment of the present invention, the molecular structure includes two or more any functional groups (also simply referred to as coordinating functional groups) in the group G1 of coordinating functional groups as coordinating functional groups that are coordinate-bonded to the different-group metal ions to be extracted.

The number of kinds of the coordinating functional groups in the acidic metal extractant is not particularly limited and may be 1 or 2 or more. The number of kinds of the coordinating functional groups is preferably 1 to 6 and more preferably 1 or 2. The kinds of the two or more coordinating functional groups in the acidic metal extractant may be the same as or different from each other and are preferably the same as each other. In particular, it is preferable that the two or more coordinating functional groups in the acidic metal extractant have the same chemical structure. In addition, the total number of the coordinating functional groups in the acidic metal extractant is not particularly limited as long as it is 2 or more, and can be appropriately set. For example, the total number of the coordinating functional groups is preferably 2 to 6, more preferably 2 to 4, and still more preferably 2.

### <Group G1 of Coordinating Functional Groups>

A carboxy group, a phosphate group, a phosphonate group, a sulfonate group (—S(═O)₂OR^{C}), and a sulfinate group (—S(═O)OR^{C}).

The phosphate group and the phosphonate group are typically represented by —OP(═O)(OR^{C})₂ and —P(═O)(OR^{C})₂, respectively. The phosphate group and the phosphonate group as the coordinating functional groups in the present invention refer to groups represented by X^{A}P(═Z)(X^{B}R^{C})₂ and —P(═Z)(X^{B}R^{C})₂, respectively. Here, X^{A} represents an oxygen atom, a nitrogen atom, or a sulfur atom and preferably an oxygen atom. X^{B} represents a single bond, an oxygen atom, a nitrogen atom, or a sulfur atom and preferably an oxygen atom. Z represents an oxygen atom or a sulfur atom and preferably an oxygen atom. A combination of X^{A}, X^{B}, and Z in each of the groups is not particularly limited and can be appropriately set. The phosphate group and the phosphonate group are still more preferably groups represented by —OP(═O)(OR^{C})₂ and —P(═O)(OR^{C})₂, respectively where all of X^{A}, X^{B}, and Z represent an oxygen atom.

In the present invention, R^{C} in the coordinating functional group represents a hydrogen atom or a substituent. The substituent that can be used as R^{C} is not particularly limited, and examples thereof include groups selected from the substituent Z described below. In particular, as the substituent that can be used as R^{C}, from the viewpoint of solubility in the oil phase, a hydrocarbon group such as an alkyl group, an alkenyl group, an alkynyl group, or an aryl group is preferable, an alkyl group, an alkenyl group, or an alkynyl group is more preferable, and an alkyl group is still more preferable. It is preferable that the alkyl group, the alkenyl group, and the alkynyl group that can be used as R^{C} have the same definitions as the respective groups that can be used as R² of Formula (I) described below irrespective of the description (in particular, the number of carbon atoms) of the substituent Z.

The two R^{C}'s in the phosphate group and the phosphonate group may be the same as or different from each other and are preferably different from each other. In addition, among the plurality of R^{C}'s in the acidic metal extractant, it is preferable that at least one R^{C} is different from the remaining R^{C}'s, and it is more preferable that at least one R^{C} represents a hydrogen atom. From the viewpoints of solubility in the oil phase, the selectivity, and the recovery rate, it is more preferable that, in one coordinating functional group, one R^{C} represents a hydrogen atom and the remaining one R^{C} represents a substituent (an acidic coordinating functional group).

The carboxy group may form a salt. In addition, in a case where the Re represents a hydrogen atom, the phosphate group, the phosphonate group, the sulfonate group, or the sulfinate group may form a salt. A cation that forms a salt is not particularly limited, and examples thereof include a metal cation, in particular, a metal cation belonging to Group 1 or Group 2, and an organic cation. The organic cation is not particularly limited, and examples thereof include an ammonium cation and an alkylammonium cation.

As the coordinating functional group in the acidic metal extractant, among the functional groups belonging to the group G1 of coordinating functional groups, a carboxy group, a phosphate group, or a phosphonate group is preferable, a phosphate group or a phosphonate group is more preferable, and a phosphonate group is still more preferable.

In a case where the acidic metal extractant includes plural kinds of coordinating functional groups, a combination of the coordinating functional groups is not particularly limited, and the coordinating functional groups in the group G1 of coordinating functional groups can be appropriately combined with each other.

As the acidic metal extractant, a carboxylic acid compound where two or more carboxy groups are introduced into the above-described linking group, a phosphate compound where two or more phosphate groups or phosphonate groups are introduced into the above-described linking group, or a sulfonate compound where two or more sulfonate groups or sulfinate groups are introduced into the above-described linking group is preferable, and a phosphate compound where two or more phosphate groups or phosphonate groups are introduced into the above-described linking group is preferable from the viewpoint of the selectivity and the recovery rate of the metal ions. The carboxylic acid compound, the phosphate compound, or the sulfonate compound is a compound including a carboxy group, a phosphate group or phosphonate group, or a sulfonate group or sulfinate group in the maximum amount as the coordinating functional group, and may include other coordinating functional groups.

The acidic metal extractant may include a substituent other than the coordinating functional groups in the group G1 of coordinating functional groups, and examples of the substituent that may be included in the acidic metal extractant include groups selected from the substituent Z described below.

The molecular weight of the acidic metal extractant is not particularly limited and can be, for example, 150 to 2,000. From the viewpoints of solubility in the oil phase, the molecular weight is preferably 180 to 1400 and more preferably 200 to 800.

The acidic metal extractant includes two or more coordinating functional groups, and at least one of the coordinating functional groups includes a carboxy group or each of acidic coordinating functional groups where one of R^{C}'s represents a hydrogen atom. In the present invention, the acidic metal extractant is an acidic metal extractant for dissociating hydrogen ions (H⁺) and can be defined by an acid dissociation constant pKa. For example, an acidic metal extractant having pkA of 0.1 to 12 is preferable, an acidic metal extractant having pkA of 0.5 to 12 is more preferable, and an acidic metal extractant having pkA of 1 to 8 is still more preferable. In the present invention, the pKa is a value measured by neutralization titration.

The acidic metal extractant according to the embodiment of the present invention is preferably represented by Formula (I) described below. The compound represented by Formula (I) described below is a phosphate compound having two phosphate groups or phosphonate groups.

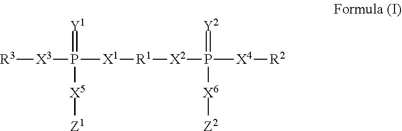

In Formula (I), R¹ represents a substituted or unsubstituted alkylene group, a substituted or unsubstituted alkenylene group, or a substituted or unsubstituted alkynylene group.

Each of the alkylene group, the alkenylene group, and the alkynylene group that can be used as R¹ may be linear, branched, or cyclic and is preferably linear or branched and more preferably linear. In a case where the number of carbon atoms is 2 or more, each of the alkylene group, the alkenylene group, and the alkynylene group is still more preferably linear and carbon atoms at both ends are bonded to X¹ or X² in Formula (I).

The total number of carbon atoms (the number of all of carbon atoms) in the alkylene group, the alkenylene group, and the alkynylene group is not particularly limited, is appropriately set, and is, for example, preferably 1 to 20, more preferably 1 to 15, still more preferably 1 to 12, still more preferably 1 or 3, and most preferably 1 from the viewpoint of easy coordination to metal ions, stability of coordinating ions, and the like. Note that, in the alkylene group, the alkenylene group, and the alkynylene group, the number of carbon atoms forming the shortest carbon chain that bonds X¹ and X² in Formula (I) can be 1 to 10 and is preferably 1 to 6, more preferably 1 to 4, still more preferably 1 or 3, and particularly preferably 1 in consideration of easy coordination to metal ions, stability of coordinating ions, and the like. In the present invention, it is preferable that the total number of carbon atoms in each of the groups and the number of carbon atoms forming the shortest carbon chain that bonds X¹ and X² are the same. The number of carbon atoms forming a substituent in each of the groups is not added to the number of carbon atoms forming each of the groups and the number of carbon atoms forming the shortest carbon chain.

Each of the alkylene group, the alkenylene group, and the alkynylene group may include a substituent but preferably does not include a substituent. The substituent that may be included in the alkylene group, the alkenylene group, and the alkynylene group is not particularly limited, is, for example, a group selected from the substituent Z described below (note that, excluding the above-described coordinating functional group), and specific examples thereof include an alkoxy group, an amino group, and an alkyl group (preferably a methyl group or an ethyl group).

R¹ represents preferably a substituted or unsubstituted alkylene group, more preferably an unsubstituted alkylene group, still more preferably an unsubstituted alkylene group having 1 or 3 carbon atoms in total, and still more preferably an unsubstituted methylene group.

R² and R³ each independently represent a substituted or unsubstituted alkyl group, a substituted or unsubstituted alkenyl group, or a substituted or unsubstituted alkynyl group.

Each of the alkylene group, the alkenylene group, and the alkynylene group that can be used as R² and R³ may be linear, branched, or cyclic and is preferably linear or branched and more preferably branched. In a case where each of the groups that can be used as R² and R³ is branched, the number of branched carbon atoms present in each of the groups is not particularly limited, can be, for example, 1 to 8, and is preferably 1 or 2.

The number of carbon atoms in each of the groups that can be used as R² and R³ is not particularly limited, is appropriately set, and is, for example, preferably 1 to 30, more preferably 6 to 20, and still more preferably 6 to 15 from the viewpoint of solubility in the oil phase. In one preferable aspect, the upper limit in each of the ranges regarding the number of carbon atoms in each of the groups is 11. In the present invention, a group having 6 or more carbon atoms will also be referred to as “long chain”. The molecular weight in each of the groups that can be used as R² and R³ is not particularly limited, and can be appropriately set. The molecular weight is set in the above-described range of the number of carbon atoms in one preferable aspect, and any group of R² or R³ has a molecular weight of less than 160 in one preferable aspect.

R² and R³ may be the same as or different from each other and are preferably the same as each other. A combination of R² and R³ is not particularly limited, and an appropriate combination can be adopted. A combination of alkyl groups is preferable, and a combination of unsubstituted alkyl groups is more preferable.

Each of the groups that can be used as R² and R³ may include a substituent but preferably does not include a substituent. The substituent that may be included in each of the groups is not particularly limited, and is, for example, a group selected from the substituent Z described below (note that, excluding the above-described coordinating functional group).

A combination of R¹, R², and R³ is not particularly limited, and examples thereof include combinations of preferable examples of R¹, R², and R³. Specifically, a combination where R¹ represents a substituted or unsubstituted alkylene group and any of R² or R³ represents a substituted or unsubstituted alkyl group is preferable, and a combination where R¹ represents an unsubstituted alkylene group and any of R² or R³ represents an unsubstituted alkyl group is more preferable.

X¹ to X⁶ each independently represent a single bond, —O—, —NH—, or —S—. Note that at least one of X⁵ or X⁶ represents preferably —O— or —S— and more preferably —O—.

Both of X¹ and X² represent preferably a single bond or —O— and more preferably a single bond.

All of X³ to X⁶ represent preferably —O—, —NH—, or —S— and more preferably —O—.

All of X¹ to X⁶ may be the same as each other, and at least one thereof may be different.

A combination of X¹ to X⁶ is not particularly limited, and examples thereof include combinations of preferable examples of X¹ to X⁶. Specifically, a combination where X¹ and X² represent a single bond or —O— and X³ to X⁶ represent —O— is preferable, and a combination where X¹ and X² represent a single bond and X³ to X⁶ represent —O— is more preferable.

Y¹ and Y² each independently represent an oxygen atom or a sulfur atom and preferably an oxygen atom.

Y¹ and Y² may be the same as or different from each other and are preferably the same as each other.

A combination of Y¹ and Y² and X¹ to X⁶ is not particularly limited, and examples thereof include combinations of preferable examples of Y¹ and Y² and X¹ to X⁶. A combination where X¹ to X⁶ have the above-described combination and Y¹ and Y² represent an oxygen atom is preferable.

Z¹ and Z² each independently represent a hydrogen atom or a hydrocarbon group.

Examples of the hydrocarbon group that can be used as Z¹ and Z² include an alkyl group, an alkenyl group, an aralkyl group, and an aryl group. Among these, an alkyl group, an alkenyl group, or an aryl group is preferable, and an alkyl group is preferable. The alkyl group, the alkenyl group, the aralkyl group, and the aryl group are not particularly limited and have the same definitions as the corresponding groups of the substituent Z described below. Note that the number of carbon atoms in the alkyl group is more preferably 1 to 10, still more preferably 1 to 6, and still more preferably 1 to 4. The number of carbon atoms in the alkenyl group is more preferably 2 to 10 and still more preferably 2 to 6. The number of carbon atoms in the aralkyl group is preferably 7 to 14 and more preferably 7 to 12. The number of carbon atoms in the aryl group is more preferably 6 to 10 and still more preferably 6.

The hydrocarbon group may further include a group selected from the substituent Z as a substituent (note that excluding the above-described coordinating functional group) but is more preferably an unsubstituted hydrocarbon group.

From the viewpoint that the acidic metal extractant represented by Formula (I) is an acidic metal extractant, at least one of Z¹ or Z² represents a hydrogen atom, and it is preferable that both of Z¹ and Z² represent a hydrogen atom.

The hydrocarbon group that can be used as Z¹ and Z² and the group that can be used as R² and R³ may have different kinds but preferably have the same kind. For example, one of Z¹ or Z² and both of R² and R³ represent more preferably an alkyl group and still more preferably an unsubstituted alkyl group. On the other hand, the hydrocarbon group that can be used as Z¹ and Z¹ and the group that can be used as R² and R³ may be the same as each other but preferably are preferably different from each other from the viewpoint of at least the number of carbon atoms. For example, it is preferable that the number of carbon atoms in the hydrocarbon group that can be used as Z¹ and Z² is less than the number of carbon atoms in the group that can be used as R² and R³, and it is more preferable that the hydrocarbon group (excluding an aryl group) that can be used as Z¹ and Z² is a short chain having 1 to 6 carbon atoms (preferably 1 to 4 carbon atoms). On the other hand, it is more preferable that the group that can be used as R² and R³ is a long chain having 6 to 30 carbon atoms (preferably 6 to 20 carbon atoms).

A combination of R¹ to R³, X¹ to X⁶, Y¹ and Y², and Z¹ and Z² is not particularly limited, and examples thereof include combinations of preferable examples of R¹ to R³, X¹ to X⁶, Y¹ and Y², and Z¹ and Z².

The acidic metal extractant represented by Formula (I) may include a substituent. Examples of the substituent that may be included in the acidic metal extractant include groups selected from the substituent Z described below excluding the coordinating functional groups in the group G1 of coordinating functional groups.

The acidic metal extractant can be synthesized with reference to a well-known method, for example, the methods described in JP1984-084894A (JP-S59-084894A) and JP1991-169887A (JP-H03-169887A). Examples of the method of synthesizing the acidic metal extractant include synthesis methods described in Examples.

Specific examples of the acidic metal extractant include the following compounds in addition to compounds synthesized or prepared in Examples, but the present invention is not limited thereto. In the following specific examples, Me represents a methyl group.

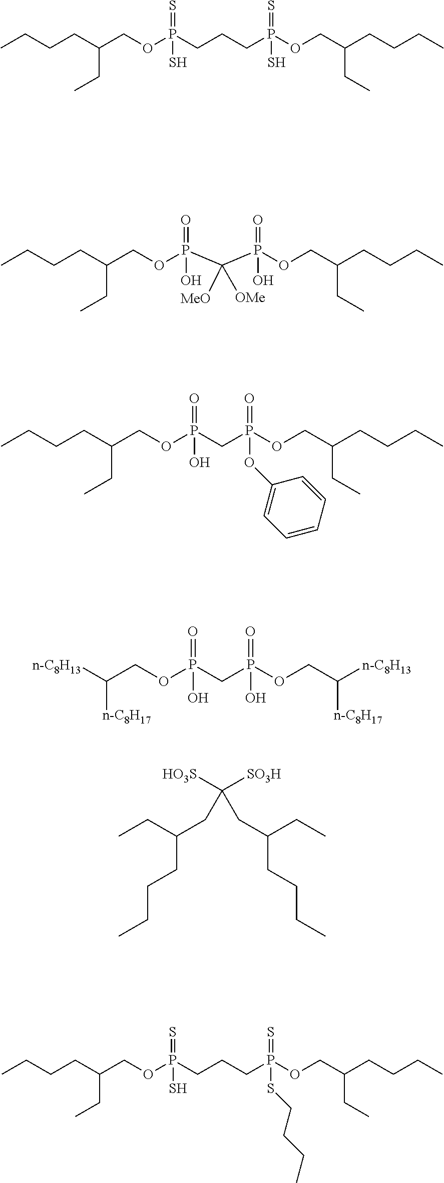

### —Substituent Z—

The substituent Z includes: an alkyl group (preferably an alkyl group having 1 to 20 carbon atoms, for example, methyl, ethyl, isopropyl, t-butyl, pentyl, heptyl, 1-ethylheptyl, benzyl, 2-ethoxyethyl, or 1-carboxymethyl); an alkenyl group (preferably an alkenyl group having 2 to 20 carbon atoms, for example, vinyl, allyl, or oleyl); an alkynyl group (preferably an alkynyl group having 2 to 20 carbon atoms, for example, ethynyl, butadiynyl, or phenyl-ethynyl); a cycloalkyl group (preferably a cycloalkyl group having 3 to 20 carbon atoms; for example, cyclopropyl, cyclopentyl, cyclohexyl, or 4-methylcyclohexyl; the meaning of an alkyl group described in the present invention typically includes a cycloalkyl group but, here, an alkyl group and a cycloalkyl group are distinguished from each other); an aryl group (preferably an aryl group having 6 to 26 carbon atoms, for example, phenyl, 1-naphthyl, 4-methoxyphenyl, 2-chlorophenyl, or 3-methylphenyl); an aralkyl group (preferably an aralkyl group having 7 to 23 carbon atoms, for example, benzyl or phenethyl); a heterocyclic group (preferably a heterocyclic group having 2 to 20 carbon atoms and more preferably a 5- or 6-membered heterocyclic group having at least one oxygen atom, sulfur atom, or nitrogen atom; the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, 2-oxazolyl, a pyrrolidone group); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); a heterocyclic oxy group (a group in which an —O— group is bonded to the above-described heterocyclic group); an alkoxycarbonyl group (preferably an alkoxycarbonyl group having 2 to 20 carbon atoms, for example, ethoxycarbonyl, 2-ethylhexyloxycarbonyl, or dodecyloxycarbonyl); an aryloxycarbonyl group (preferably an aryloxycarbonyl group having 7 to 26 carbon atoms, for example, phenoxycarbonyl, 1-naphthyloxycarbonyl, 3-methylphenoxycarbonyl, or 4-methoxyphenoxycarbonyl); a heterocyclic oxycarbonyl group (a group in which an —O—CO— group is bonded to the above-described heterocyclic group); an amino group (preferably an amino group having 0 to 20 carbon atoms, an alkylamino group, or an arylamino group, for example, amino (—NH₂), N,N-dimethylamino, N,N-diethylamino, N-ethylamino, or anilino); a sulfamoyl group (preferably a sulfamoyl group having 0 to 20 carbon atoms, for example, N,N-dimethylsulfamoyl or N-phenylsufamoyl); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, acetyl, propionyl, butyryl, octanoyl, hexadecanoyl, acryloyl, methacryloyl, crotonoyl, benzoyl, naphthoyl, or nicotinoyl); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, or nicotinoyloxy); an aryloyloxy group (preferably an aryloyloxy group having 7 to 23 carbon atoms, for example, benzoyloxy or naphthoyloxy); a carbamoyl group (preferably a carbamoyl group having 1 to 20 carbon atoms, for example, N,N-dimethylcarbamoyl or N-phenylcarbamoyl); an acylamino group (preferably an acylamino group having 1 to 20 carbon atoms, for example, acetylamino or benzoylamino); an alkylthio group (preferably an alkylthio group having 1 to 20 carbon atoms, for example, methylthio, ethylthio, isopropylthio, or benzylthio); an arylthio group (preferably an arylthio group having 6 to 26 carbon atoms, for example, phenylthio, 1-naphthylthio, 3-methylphenylthio, or 4-methoxyphenylthio); a heterocyclic thio group (a group in which an —S— group is bonded to the above-described heterocyclic group); an alkylsulfonyl group (preferably an alkylsulfonyl group having 1 to 20 carbon atoms, for example, methylsulfonyl or ethylsulfonyl); an arylsulfonyl group (preferably an arylsulfonyl group having 6 to 22 carbon atoms, for example, benzenesulfonyl); an alkylsilyl group (preferably an alkylsilyl group having 1 to 20 carbon atoms, for example, monomethylsilyl, dimethylsilyl, trimethylsilyl, or triethylsilyl); an arylsilyl group (preferably an arylsilyl group having 6 to 42 carbon atoms, for example, triphenylsilyl); an alkoxysilyl group (preferably an alkoxysilyl group having 1 to 20 carbon atoms, for example, monomethoxysilyl, dimethoxysilyl, trimethoxysilyl, or tricthoxysilyl); an aryloxysilyl group (preferably an aryloxysilyl group having 6 to 42 carbon atoms, for example, triphenyloxysilyl); a phosphoryl group (preferably a phosphate group having 0 to 20 carbon atoms, for example, —OP(═O)(R^{P})₂); a phosphonyl group (preferably a phosphonyl group having 0 to 20 carbon atoms, for example, -P(═O)(R^{P})₂); a phosphinyl group (preferably a phosphinyl group having 0 to 20 carbon atoms, for example, -P(R^{P})₂); a phosphonate group (preferably a phosphonate group having 0 to 20 carbon atoms, for example, -PO(OR^{P})₂); a sulfo group (sulfonate group); a carboxy group; a hydroxy group; a sulfanyl group; a cyano group; and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

### [Separation Recovery Method of Metal Ions]

Next, the separation recovery method of metal ions according to the embodiment of the present invention using the acidic metal extractant according to the embodiment of the present invention will be described.

The separation recovery method of metal ions according to the embodiment of the present invention comprises: extracting and separating two or more kinds of metal ions (different-group metal ions) belonging to different groups present in a water layer by mixing a water phase and an oil phase with each other, the water phase including two or more kinds of metal ions belonging to different groups among metal ions (specific metal ion group) belonging to Groups 9 and 10 of the fourth to sixth periods in a periodic table, and the oil phase including the above-described acidic metal extractant according to the embodiment of the present invention. By mixing the water phase and the oil phase, the different-group metal ions to which the acidic metal extractant according to the embodiment of the present invention is coordinated can be moved (extracted) to be separated and recovered from the water phase to the oil phase with high selectivity and high recovery rate. Here, the different-group metal ions extracted to the oil phase may include all of the kinds or may include some kinds which are two or more kinds among the plural kinds of different-group metal ions in the water phase. In the present invention, it is preferable that all kinds of the two or more kinds of different-group metal ions in the water phase are extracted to the oil phase. In the separation recovery method according to the embodiment of the present invention, one kind of metal ions can be extracted to an oil phase with high selectivity and high recovery rate as ions of a valuable metal elements among the different-group metal ions in the specific metal ion group, particularly desirably, cobalt ions and nickel ions that are the same-period different-group metal ions.

The present inventors found that the acidic metal extractant according to the embodiment of the present invention has the property and function in which, while extracting two or more kinds of different-group metal ions in the specific metal ion group present in the water phase to the oil phase together in the wet extraction method, one kind of metal ions can be extracted to the oil phase with high selectivity and high recovery rate, and applies the separation recovery method according to the embodiment of the present invention to the new use where two or more kinds of different-group metal ions are separated and recovered.

### <Water Phase>

Water formed in the water phase is not particularly limited, and (super) pure water, ion exchange water, or the like can be used.

The water phase includes metal ions (specific metal ion group) belonging to Groups 9 and 10 of the fourth to sixth periods in the periodic table, and the specific metal ion group includes two or more kinds of metal ions belonging to different groups.

The metal ions in the specific metal ion group are the metal ions belonging to Groups 9 and 10 of the fourth to sixth periods, and specific examples thereof include ions of Co, Rh, Ir, Ni, Pd, and Pt. The metal ions in the specific metal ion group are preferably metal ions belonging to Groups 9 and 10 of the fourth period or the fifth period and are more preferably metal ions belonging to Groups 9 and 10 of the fourth period. The number of kinds of the metal ions forming the specific metal ion group is 2 to 6, preferably 2 to 5, and more preferably 2 to 4.

The water phase includes two or more kinds of different-group metal ions in the above-described specific metal ion group. As the two or more kinds of different-group metal ions, ions of the Group 9 element and ions of the Group 10 can be appropriately combined. Examples of the combination include a combination of Co and Ni, Pd, or Pt, a combination of Rh and Ni, Pd, or Pt, and a combination of Ir and Ni, Pd, or Pt. Among these, a combination of Co and Ni, Pd, or Pt is preferable. As the two or more kinds of different-group metal ions, among the above-described combinations, a combination of same-period different-group metal ions that are typically known to be difficult to adopt from the viewpoint of the selectivity and the recovery rate in the wet extraction method is preferable, and examples of the combination include a combination of Co and Ni, a combination of Rh and Pd, and a combination of Ir and Pt. Among these, a combination of Co and Ni is preferable. The number of kinds of the different-group metal ions in the water phase may be 2 or more and, for example, is preferably 2 to 4 and more preferably 2.

The water phase may include metal ions other than the specific metal ion group, for example, one kind or two or more kinds of ions of metal elements belonging to groups other than Groups 9 and 10. In one aspect of the separation recovery method according to the embodiment of the present invention, it is preferable that ions of metal elements belonging to the seventh period are not included, it is more preferable that ions of metal elements belonging to the sixth and seventh periods are not included, and it is still more preferable that metal ions other than the metal ions in the specific metal ion group are not included. Here, the water phase “not including” metal ions represents that the metal ions are not actively mixed in the water phase, and does not represent that metal ions that are unavoidably mixed in the water phase are not included. For example, the metal ion content (concentration) in the water phase is 100 mass ppm or less.

The metal ions can be appropriately prepared and, for example, various metal salts (salts of metal elements with inorganic acids such as nitric acid or sulfuric acid or organic acids such as acetic acid), a mixture of mined metals (ion), a recovery from metal waste, other waste such as a metal recovery from a waste battery (LiB), or a mixture thereof can be used. Examples of the metal recovery from the waste LiB include recoveries obtained using a well-known method such as a wet process or electrolysis.

A total content of the specific metal ion group in the water phase is not particularly limited and is appropriately set. For example, the total content can be 1,000 to 1,000,000 mass ppm and is preferably 1,000 to 100,000 mass ppm and more preferably 1,000 to 50,000 mass ppm.

A total content of the metal ions belonging to Group 9 in the specific metal ion group is not particularly limited and is appropriately set. For example, the content can be 1,000 to 60,000 mass ppm and is preferably 1,000 to 30,000 mass ppm. A content of each kind of metal ions belonging to Group 9 is appropriately set in consideration of the above-described total content, can be, for example, 500 to 40,000 mass ppm, and is preferably 1,000 to 20,000 mass ppm.

A total content of the metal ions belonging to Group 10 in the specific metal ion group is not particularly limited and is appropriately set. For example, the content can be 1,000 to 60,000 mass ppm and is preferably 1,000 to 30,000 mass ppm. A content of each kind of metal ions belonging to Group 10 is appropriately set in consideration of the above-described total content, can be, for example, 500 to 40,000 mass ppm, and is preferably 1,000 to 20,000 mass ppm.

In the present invention, the content of each kind of the metal ions relating to the different-group metal ions may be more than or less than the content of the other metal ions. In the separation recovery method according to the embodiment of the present invention, the different-group metal ions can be separated and recovered with high selectivity. Therefore, the contents of the different-group metal ions do not need to be set at a specific ratio. For example, the total content of the metal ions belonging to Group 9 may be more than, less than, or the same as the total content of the metal ions belonging to Group 10. An example of a ratio between the contents of the different-group metal ions will be described. A mass ratio of the content of metal ions extracted in the maximum amount to the content of metal ions belonging to the other group (including metal ions that are not extracted) [the content of the metal ions extracted in the maximum amount: the content of the metal ions belonging to the other group] can be, for example, 100:1 to 10,000 and is preferably 100:10 to 5,000, more preferably 100:50 to 1,000, and still more preferably 100:70 to 130.

In the present invention, in a case where the water phase includes metal ions other than the specific metal ion group, the total content thereof is not particularly limited and is preferably 50,000 mass ppm or less and more preferably 30,000 mass ppm or less.

The pH of the water phase is not particularly limited and is appropriately set. For example, the pH of the water phase is preferably 0.1 to 10 in consideration of the solubility of the metal ions, the formation of complex ions, and the like, is more preferably 0.5 to 7.0 from the viewpoints of the selectivity, the recovery rate, and the like, and is still more preferably 1.0 to 6.5 and still more preferably 5.0 to 6.5 from the viewpoint that the recovery rate can be particularly improved. The pH of the water phase can be adjusted, for example, using an acid or an alkali. As the acid, a well-known acid can be used without any particular limitation, and examples thereof include an inorganic acid such as sulfuric acid, hydrochloric acid, nitric acid, or phosphoric acid and an organic acid such as formic acid, acetic acid, oxalic acid, organic phosphoric acid, or organic sulfonic acid. As the alkali, a well-known alkali can be used without any particular limitation, and examples thereof include an inorganic alkali and an organic alkali. Among these, an inorganic alkali is preferable. Examples of the inorganic alkali include a hydroxide of a metal belonging to Group 1 or Group 2, a metal alkali such as a carbonate, ammonia water, and ammonium chloride. Examples of the organic alkali include an organic ammonium salt.

The temperature of the water phase is not particularly limited and can be, for example, 10° C. to 60° C.

The water phase may optionally include, for example, a ligand coordinated to metal ions or a compound that generates the ligand.

The water phase can be prepared by dissolving various metal ions in water. Preparation conditions of the water phase are not particularly limited. For example, the preparation temperature can be 10° C. to 60° C.

### <Oil Phase>

In the separation recovery method according to the embodiment of the present invention, the oil phase (organic phase) including one kind or two or more kinds of the acidic metal extractants according to the embodiment of the present invention is used for the above-described water phase.

The acidic metal extractant according to the embodiment of the present invention exhibits solubility in an organic solvent, is present in the oil phase, is coordinate-bonded to metal ions present in the vicinity of an interface between the water phase and the oil phase, and has a function of moving the two or more kinds of different-group metal ions to the oil phase. In the present invention, the solubility in the organic solvent refers to a property in which the acidic metal extractant is soluble in the organic solvent in a content described below.

The organic solvent for forming the oil phase is not particularly limited, and an appropriate organic solvent can be used. Examples of the organic solvent include an alcohol solvent, an ether solvent, a hydrocarbon-based solvent (an aromatic solvent or an aliphatic solvent), and a halogen solvent. In particular, a hydrocarbon-based solvent is preferable, various solvents as components separated from petroleum are more preferable, and hydrocarbon-based solvents of aromatic groups, paraffin, naphthene, kerosine, gasoline, naphtha, heating oil, and light oil are still more preferable.

The content of the acidic metal extractant in the oil phase is appropriately set in consideration of each of the contents of the metal ions, the amount of coordination to the metal ions, the number of the coordinating functional groups, and the like. For example, the content in the oil phase can be 20 to 10,000 millimole/L (mM), and is preferably 50 to 1,000 millimole/L and more preferably 100 to 500 millimole/L.

The temperature of the oil phase is not particularly limited and can be, for example, 10° C. to 60° C.

The oil phase may include appropriate components in addition to the acidic metal extractant according to the embodiment of the present invention.

The oil phase can be prepared by dissolving the acidic metal extractant in the organic solvent. Preparation conditions of the oil phase are not particularly limited. For example, the preparation temperature can be 10° C. to 60° C.

### (Contact and Mixing)

In the separation recovery method according to the embodiment of the present invention, the water phase and the oil phase described above are mixed and left to stand.

In this case, mixing conditions and standing conditions are not particularly limited and can be appropriately set. For example, mixing can be performed using various mixing devices. Examples of a method using the mixing device include a method using a magnetic stirrer (stirrer tip), a method using a mechanical stirrer, and a method using a mixer. Stirring conditions (a stirring rate, a stirring time, and the like) only need to be conditions (conditions where the acidic metal extractant is coordinate-bonded to the metal ions) where the water phase and the oil phase can be mixed, and are appropriately set depending on the combination of the metal ions and the acidic metal extractant, and the mixing temperature, and the mixing device. For example, the stirring time is not uniquely determined depending on the stirring conditions and the like, and can be, for example, 10 minutes to 24 hours.

The standing conditions only need to be conditions where the water phase and the oil phase are separated into two layers. For example, the standing time can be 10 minutes to 24 hours after stopping mixing.

The mixing temperature and the standing temperature are not particularly limited and can be, for example, 10° C. to 60° C.

During the mixing of the water phase and the oil phase, a mixing ratio between the water phase and the oil phase is appropriately set depending on a metal ion concentration, a concentration of the metal ions, the content (concentration) of the acidic metal extractant, and the like, and is not uniquely determined. For example, in a case where the water phase and the oil phase that satisfy the respective concentrations are mixed, the ratio of the oil phase to 100 mL of the water phase can be 50 to 2,000 mL and is preferably 80 to 1,000 mL and more preferably 80 to 200 mL. On the other hand, focusing on the metal ions present in the water phase, it is preferable that the oil phase is mixed at a ratio of 0.5 to 20 moles of the acidic metal extractant to the total content (moles) of the specific metal ion group. In addition, the content of the acidic metal extractant with respect to the total content of the metal ions to which the acidic metal extractant can be coordinated (also referred to as the mixing amount; a ratio of the number of moles of the metal extractant to the total number of moles of the metal ions:molar ratio) can be, for example, 0.5 to 20.0 equivalents. Here, the metal ions to which the acidic metal extractant can be coordinated refers to different-group metal ions that are coordinated to the acidic metal extractant and are extracted to the oil phase.

During the mixing of the water phase and the oil phase, the pH of the mixing system can be adjusted. Here, the pH that is set for specific metal ions to be extracted is not uniquely determined and is appropriately determined in consideration of the pKa of the metal extractant, the complex formation constants of the metal extractant and the metal ions, the number of metal ions to be coordinated, and the like. The pH of the mixing system can be, for example, 2 to 14 and is more preferably 3.0 to 7.0, and still more preferably 3.0 to 5.0. The preparation of the pH can be performed using the acid or the alkali described above, an aqueous solution thereof, or the like, and one preferable aspect is an aspect where ammonium ions are not used.

In a case where the pH of the mixing system is adjusted during the mixing of the water phase and the oil phase, the mixing of the water phase and the oil phase and the standing after the mixing are performed after adjusting the pH.

In a two-phase separated fluid (a solvent extraction phase or a solvent extraction system) where the water phase and the oil phase are phase-separated that is obtained by mixing the water phase and the oil phase and leaving the mixture to stand, the water phase and the oil phase are phase-separated into layers and present in a state where they are in contact with each other. The two or more kinds of different-group metal ions to which the acidic metal extractant is coordinate-bonded in the above-described specific metal ion group are present (moved) in the oil phase. The two or more kinds of different-group metal ions that are extracted to the oil phase in the specific metal ion group are not particularly limited and, for example, are preferably the same as the above-described two or more kinds of different-group metal ions (combination) in the water phase. The number of kinds of the different-group metal ions extracted to the oil phase may be 2 or more and, for example, is preferably 2 to 4 and more preferably 2.

In the separation recovery method according to the embodiment of the present invention, using a simple method of mixing the water phase and the oil phase with each other and leaving the mixture to stand, while extracting two or more kinds of different-group metal ions in the specific metal ion group to the oil phase, one kind of metal ions can be separated and recovered to an oil phase with high selectivity and high recovery rate.

The one kind of metal ions that can be separated and recovered with high selectivity and high recovery rate are not uniquely determined depending on the group or the period of the metal ions, the content thereof, the kind of the acidic metal extractant, and the like. For example, metal ions belonging to Group 9 can be separated and recovered with high selectivity and high recovery rate, and Co ions or Rh ions that are metal ions belonging to Group 9 can be separated and recovered with high selectivity and high recovery rate in the coexistence of the same-period different-group metal ions.

In the separation recovery method according to the embodiment of the present invention, as described above, while extracting two or more kinds of different-group metal ions in the specific metal ion group present in the water phase to the oil phase, one kind of metal ions, in particular, metal ions belonging to Group 9 can be separated and recovered to the oil phase with high selectivity and high recovery rate. Therefore, by further subjecting the water phase including the two or more kinds of different-group metal ions stripped from the oil phase to the separation recovery method according to the embodiment of the present invention, the selectivity of one kind of metal ions can be further improved without significant deterioration in recovery rate, and thus high-purity metal ions can be recovered with high recovery rate.

The separation recovery method according to the embodiment of the present invention can also be a method of extracting two or more kinds of metal ions.

In the separation recovery method according to the embodiment of the present invention, the acidic metal extractant alone can be coordinated to metal ions to extract the metal ion to the oil phase. Therefore, the water phase and the oil phase do not need to include a ligand coordinated to metal ions or a compound that generates the ligand. In the separation recovery method according to the embodiment of the present invention, typically, the water phase including the specific metal ion group as an essential component and the oil phase including the acidic metal extractant according to the embodiment of the present invention as an essential component are used.

The separation recovery method according to the embodiment of the present invention may include steps other than the step of mixing the water phase and the oil phase with each other and leaving the mixture to stand. Examples of the other steps include a method of stripping (isolating) different-group metal ions from the oil phase obtained in the step of mixing the water phase and the oil phase with each other and leaving the mixture to stand, a step of recovering the stripped different-group metal ions as a compound (salt), a step of purifying the stripped different-group metal ions or the compound thereof, and a step of removing ions of metal elements belonging to Group 1 or Group 2 in the periodic table of elements in advance. As a method of stripping (isolating) the different-group metal ions from the oil phase, a well-known method can be applied without any particular limitation. For example, the different-group metal ions can be stripped by adjusting the liquid phase to be acidic, for example, pH of 2 to 4 using an inorganic acid such as sulfuric acid, hydrochloric acid, or nitric acid. As a method of recovering the stripped different-group metal ions as a compound, a well-known method can be applied without any particular limitation.

### EXAMPLES

Hereinafter, the present invention will be described in more detail based on Examples but is not limited to these examples. “Parts” and “%” that represent compositions in the following examples are mass-based unless particularly otherwise described.

### [Synthesis and Preparation of Acidic Metal Extractant]

Metal extractants shown below were synthesized and prepared.

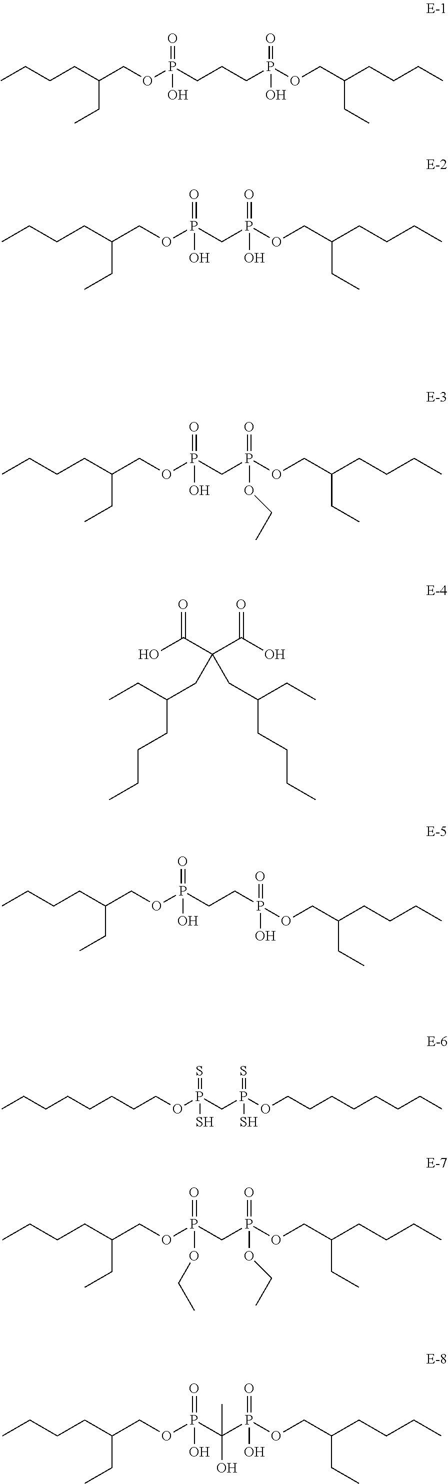

PC-88A: mono-2-ethylhexyl (2-Ethylhexyl)phosphonate shown below (manufactured by Tokyo Chemical Industry Co., Ltd.)

VA-10: Versatic acid 10 (manufactured by Hexion Specialty Chemicals, Inc.)

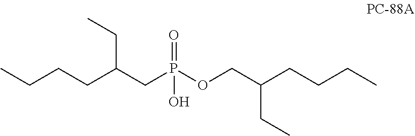 [SMILES: CCCCC(CC)COP(=O)(O)CC(CC)CCCC]

### <Synthesis of Acidic Metal Extractant E-1>

An acidic metal extractant E-1 was synthesized as follows.

An acidic metal extractant E-1 was synthesized using the same method as that of synthesis of an acidic metal extractant E-2 described below, except that methylenediphosphonic acid was changed to 1,3-propylenediphosphonic acid during the synthesis of the acidic metal extractant E-2. The obtained acidic metal extractant E-1 was identified using the same method as that of the acidic metal extractant E-2.

### <Synthesis of Acidic Metal Extractant E-2>

The acidic metal extractant E-2 was synthesized as follows.

That is, 15.4 g of methylenediphosphonic acid (manufactured by Tokyo Chemical Industry Co., Ltd.), 22.8 g of 2-ethylhexanol (manufactured by FUJIFILM Wako Pure Chemical Corporation), and 150 g of tetrahydrofuran (manufactured by FUJIFILM Wako Pure Chemical Corporation) were added to a 500 mL three-necked eggplant flask, and were stirred and dissolved in a reflux state.

Separately from this process, a solution of 39.7 g of N,N′-dicyclohexylcarbodiimide (manufactured by FUJIFILM Wako Pure Chemical Corporation) and 150 g of tetrahydrofuran was prepared in a 500 mL measuring cylinder.

This solution was added dropwise to the above-described three-necked eggplant flask for 3 hours, and was further stirred for 5 hours after completion of the dropwise addition. The obtained solution was allowed to cool at room temperature, the precipitated white crystals were removed by filtration, and the filtrate was cleaned with toluene. The solvent was distilled off under a reduced pressure from the filtrate to obtain a compound E-2 as a transparent liquid (yield: 98%).

The acidic metal extractant E-2 synthesized as described above was identified as follows.

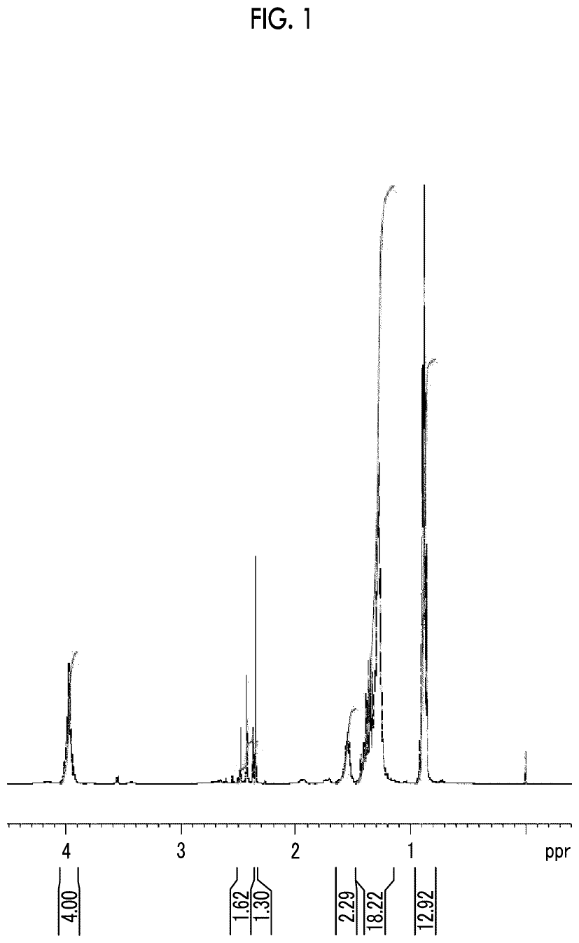

That is, ¹H-NMR was measured in deuterated chloroform (device: BRUKER 400). The results are shown in FIG. 1.

In the ¹H-NMR chart shown in FIG. 1, an integration ratio between a hydrogen atom (δ 3.98) positioned adjacent to an O atom of a 2-ethylhexyloxy group and a hydrogen atom (δ 2.35) directly connected to a carbon atom interposed between P atoms was about 4:2. Therefore, it can be seen that two 2-ethylhexyl groups were introduced into the methylenediphosphonic acid. Accordingly, the obtained compound was identified to have the above-described structure represented by E-2.

### <Synthesis of Acidic Metal Extractant E-3>

An acidic metal extractant E-3 was synthesized as follows.

That is, 35.0 g of the acidic metal extractant E-2, 11.4 g of ethanol (manufactured by FUJIFILM Wako Pure Chemical Corporation), and 100 g of tetrahydrofuran were added to a 500 mL three-necked eggplant flask, and were stirred in a reflux state. Separately from this process, a solution of 21.6 g of N,N′-dicyclohexylcarbodiimide (manufactured by FUJIFILM Wako Pure Chemical Corporation) and 100 g of tetrahydrofuran was prepared in a 500 ml measuring cylinder. This solution was added dropwise to the above-described three-necked eggplant flask for 3 hours, and was further stirred for 5 hours after completion of the dropwise addition. The obtained solution was allowed to cool at room temperature, the precipitated white crystals were removed by filtration, and the filtrate was cleaned with toluene. The solvent was distilled off under a reduced pressure from the filtrate to obtain a compound E-3 as a transparent liquid (yield: 98%).

The acidic metal extractant E-3 synthesized as described above was identified as follows.

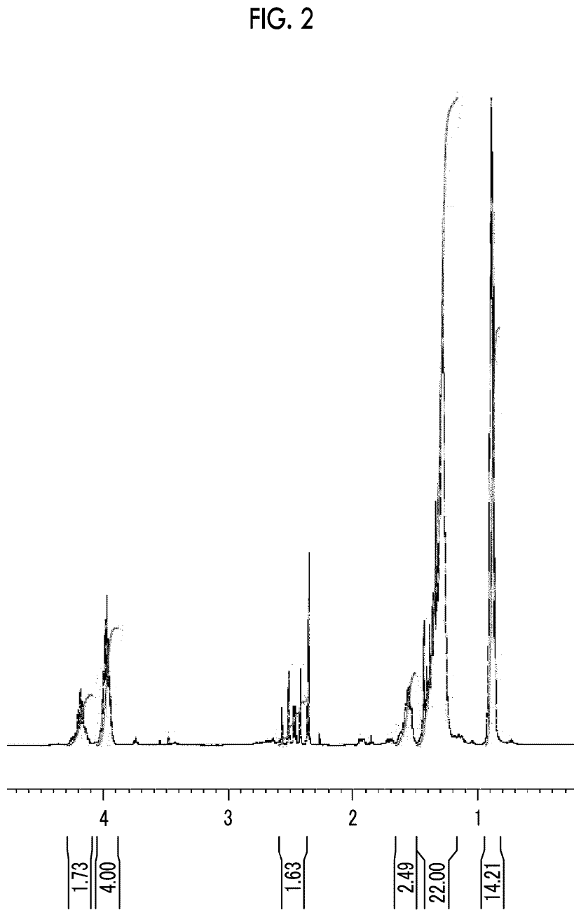

That is, ¹H-NMR was measured in deuterated chloroform (device: BRUKER 400), and the obtained chart is shown in FIG. 2. In addition, fragment-ions of the compound were detected by LC-MS (device: LCMS-8050).

In the ¹H-NMR chart shown in FIG. 2, an integration ratio between a hydrogen atom (δ 3.97) positioned adjacent to an O atom of a 2-ethylhexyloxy group and a hydrogen atom (δ 2.42) directly connected to a carbon atom interposed between P atoms was about 4:2. Therefore, it can be seen that two 2-ethylhexyl groups were introduced into the methylenediphosphonic acid. In addition, an integration ratio between a hydrogen atom (δ 3.97) positioned adjacent to an O atom of a 2-ethylhexyloxy group and a hydrogen atom (δ 4.19) positioned adjacent to an O atom of an ethoxy group was about 2:1. Therefore, it is estimated that the 2-ethylhexyl group and the ethyl group were introduced at 2:1. In addition, fragment-ions of 429.4 were obtained by LC-MS. The exact mass of the acidic metal extractant E-3 was 428.3 and thus was estimated to correspond to [M+H]⁺ ions.

As a result, the obtained compound was identified to have the above-described structure represented by E-3.

### <Synthesis of Acidic Metal Extractant E-4>

An acidic metal extractant E-4 was synthesized as follows.

That is, 300 g of ethanol, 43.8 g of sodium ethoxide (manufactured by FUJIFILM Wako Pure Chemical Corporation), 112 g of 1-bromo-2-ethylhexane (manufactured by Tokyo Chemical Industry Co., Ltd.), and 46.4 g of diethyl malonate (manufactured by Tokyo Chemical Industry Co., Ltd.) were added to a 1 L three-necked eggplant flask and were stirred in a reflux state for 12 hours. Solid precipitated from the obtained solution was removed by filtration, and a part of the solvent was distilled off under a reduced pressure from the filtrate. 100 g of water was added to the obtained solution, a 2 M (mol/L) of hydrochloric acid was added until the pH reached 1 to 2, an extraction operation using toluene was performed, and the solvent of the organic phase was distilled off. As a result, diethyl 2,2-bis(2-ethylhexyl) malonate was obtained (yield 97%).

Next, 550 g of ethanol, 550 g of a 4 M NaOH solution, and 108 g of diethyl 2,2-bis(2-ethylhexyl) malonate were added to a 2 L three-neck flask, and were stirred in a reflux state for 7 hours. The obtained solution was allowed to cool at room temperature, ethanol was distilled off under a reduced pressure, and 450 g of toluene was added. The water layer was cleaned with toluene three times, a 2 M hydrochloric acid was added to adjust the pH to 1 to 2, the compound was extracted with toluene, and the solvent was distilled off under a reduced pressure from the organic layer. As a result, the acidic metal extractant E-4 was synthesized (yield: 98%).

### <Synthesis of Acidic Metal Extractant E-5>

An acidic metal extractant E-5 was synthesized as follows.

The acidic metal extractant E-5 was synthesized using the same method as that of the synthesis of the acidic metal extractant E-2, except that methylenediphosphonic acid was changed to 1,2-ethylenediphosphonic acid during the synthesis of the acidic metal extractant E-2. The obtained acidic metal extractant E-5 was identified using the same method as that of the acidic metal extractant E-2.

### <Synthesis of Acidic Metal Extractant E-6>

An acidic metal extractant E-6 was synthesized as follows.

The metal extractant E-6 was synthesized and identified using a method of synthesizing a compound 1c described in J. Org. Chem. 2013, 78, 270-277.

### <Synthesis of Metal Extractant E-7>

A metal extractant E-7 was synthesized as follows.

A metal extractant E-7 was synthesized using the same method as that of the synthesis of the acidic metal extractant E-3, except that 22.8 g of ethanol and 43.2 g of N,N′-dicyclohexylcarbodiimide were used. The obtained metal extractant E-7 was identified using the same method as that of the acidic metal extractant E-3.

### <Synthesis of Acidic Metal Extractant E-8>

An acidic metal extractant E-8 was synthesized as follows.

The metal extractant E-8 was synthesized and identified using the synthesis method of the compound described in Example 1 of JP1991-169887A (JP-H03-169887A).

Regarding the synthesized or prepared acidic metal extractant, the molecular weight and the pKa calculated using the above-described method are shown in Table 1-2.

### [Preparation of Metal Ion-Containing Aqueous Solution (Water Phase)]

71.6 g of cobalt (II) sulfate heptahydrate (manufactured by FUJIFILM Wako Pure Chemicals Corporation) and 71.8 g of nickel (II) sulfate heptahydrate (manufactured by FUJIFILM Wako Pure Chemicals Corporation) were added to a 1 L measuring flask, were diluted with ultrapure water, and were stirred and dissolved at 40° C. As a result, a metal ion-containing aqueous solution (W1) including two kinds of different-group metal ions was prepared.

In addition, by dissolving each of sulfates in ultrapure water with the combination of metal ions shown in Table 1-1, a metal ion-containing aqueous solution (W2) including two kinds of different-group metal ions and a metal ion-containing aqueous solution (W3) including cobalt ions and manganese ions were prepared, respectively.

### <Preparation of Metal Extractant Solution (Oil Phase)>

Each of the synthesized or prepared metal extractants was added to a 100 mL measuring flask, and was diluted using kerosine (manufactured by FUJIFILM Wako Pure Chemicals Corporation) at room temperature. As a result, acidic metal extractant solutions (Y1) to (Y6), (Y8), (Yc1), and (Yc2) (concentration: 310 mM) containing the acidic metal extractants were prepared, respectively.

A metal extractant solution (Y7) was prepared using the same method as that of the preparation of the acidic metal extractant solution (Y1), except that the metal extractant E-7 was used instead of the acidic metal extractant E-1 during the preparation of the acidic metal extractant solution (Y1).

### Example 1

12 mL of the acidic extractant (Y1) with respect to 10 mL of the prepared metal ion-containing aqueous solution (W1) was added to a 30 mL vial tube, and the mixture was stirred using a stirrer tip at 25° C. for 30 minutes. In this case, the mixing amount (unit: equivalent) of the acidic metal extractant with respect to the total content of metal ions to be coordinated (that have the same definition as the extracted different-group metal ions; in Example 1, Co and Ni) was 0.73. Next, a 10 M sodium hydroxide aqueous solution or a 10 M hydrochloric acid was added to adjust the pH of the mixed solution to a value shown in the column “pH during Mixing” of Table 1-2. Further, the solution was stirred at 25° C. for 30 minutes, and was left to stand at the same temperature for 1 hour. After verifying that the solution was separated into two layers of the organic phase (oil phase) and the water phase, the separated water phase was extracted, and the separation and recovery of the metal ions was performed. The metal ions extracted in Example 1 and the metal ions extracted in the maximum amount are shown in the column “Kind” and the column “Maximum Amount Extracted” of the column “Extracted Metal Ions” in Table 1-2, respectively.

### Examples 2 to 9 and Comparative Examples 1 to 4

Separation and recovery of metal ions according to Examples 2 to 9 and Comparative Examples 1 to 4 were performed using the same method as that of Example 1, except that the metal ion-containing aqueous solution and the metal extractant solution were changed to a combination shown in the column “Water Phase” of Table 1-1 and the column “Oil Phase” of Table 1-2 (hereinafter, both of which are referred to as Table 1″), the pH during the mixing of the water phase and the oil phase was set to a value shown in the column “pH during Mixing” of Table 1-2, and the mixing amount (unit: equivalent) of the acidic metal extractant with respect to the total content of metal ions to be coordinated was set to a value shown in the column “Mixing Amount” of Table 1-2 for mixing and standing. The metal ions extracted in each of Examples and the metal ions extracted in the maximum amount are shown in the column “Kind” and the column “Maximum Amount Extracted” of the column “Extracted Metal Ions” in Table 1-2, respectively.

Regarding each of the water phases used in Examples and Comparative Examples and the water phases after the extraction, the pH was measured using a pH meter (SK-620 pH II, manufactured by SATOTECH), and each of the contents of dissolved metal ions was determined using an inductively coupled plasma-optical emission spectrometer (ICP-OES) (Optima 7300 D (trade name), manufactured by Perkin Elmer Co., Ltd.). Measured values of the pH of each of the water phases used in Examples and Comparative Examples and the content of dissolved metal ions in each of the water phases are shown in the column “Water Phase pH” of Table 1-2, the column “Metal Ion Concentration in Water Phase before Extraction (ppm)” of Table 1-1, and the column “Metal Ion Concentration in Water Phase after Extraction (ppm)” of Table 1-1, respectively. The maximum amount (ppm) of the metal ions extracted measured as described above was divided by the total amount (ppm) of the other metal ions extracted to calculate a ratio between the amounts thereof extracted. The result is shown in the column “Selection Ratio” of Table 1-2. Regarding Comparative Examples 1 and 2 where the other metal ions were not extracted, “Selection Ratio” was shown as “100”.

In addition, in Examples and Comparative Examples, the results measured using the same method as that of the pH during the mixing of the water phase and the oil phase are shown in the column “pH during Mixing”. Further, the mixing amount of the acidic metal extractant with respect to the total content of the metal ions to be coordinated is shown in the column “Mixing Amount” of Table 1-2. In Table 1-2, the unit of the mixing amount is equivalent but is not shown.

In a case where the same experiment was performed using the same method as that of Examples 1 to 9 and Comparative Examples 1 to 4, except that the metal ion concentration in the water layer was reduced to ⅕, the same results were obtained.

TABLE 1

| | | Metal Ion Concentration in Water Phase before | | | | | Metal Ion Concentration in Water Phase after | | | | |
|---|---|---|---|---|---|---|---|---|---|---|---|
| | Water | Extraction (ppm) | | | | | Extraction (ppm) | | | | |
| No. | Phase | Co | Ni | Rh | Pd | Mn | Co | Ni | Rh | Pd | Mn |
| Example 1 | W1 | 15,000 | 15,000 | 0 | 0 | 0 | 0 | 7,500 | 0 | 0 | 0 |
| Example 2 | W1 | 15,000 | 15,000 | 0 | 0 | 0 | 0 | 14,500 | 0 | 0 | 0 |
| Example 3 | W1 | 15,000 | 15,000 | 0 | 0 | 0 | 0 | 14,200 | 0 | 0 | 0 |
| Example 4 | W1 | 15,000 | 15,000 | 0 | 0 | 0 | 0 | 4,500 | 0 | 0 | 0 |
| Example 5 | W2 | 0 | 0 | 15,000 | 15,000 | 0 | 0 | 0 | 0 | 14,000 | 0 |
| Example 6 | W2 | 0 | 0 | 15,000 | 15,000 | 0 | 0 | 0 | 0 | 13,500 | 0 |
| Example 7 | W1 | 15,000 | 15,000 | 0 | 0 | 0 | 0 | 7,000 | 0 | 0 | 0 |
| Example 8 | W1 | 15,000 | 15,000 | 0 | 0 | 0 | 0 | 6,500 | 0 | 0 | 0 |
| Example 9 | W1 | 15,000 | 15,000 | 0 | 0 | 0 | 0 | 4,500 | 0 | 0 | 0 |
| Comparative | W1 | 15,000 | 15,000 | 0 | 0 | 0 | 12,000 | 15,000 | 0 | 0 | 0 |
| Example 1 | | | | | | | | | | | |
| Comparative | W1 | 15,000 | 15,000 | 0 | 0 | 0 | 13,000 | 15,000 | 0 | 0 | 0 |
| Example 2 | | | | | | | | | | | |
| Comparative | W3 | 15,000 | 0 | 0 | 0 | 15,000 | 1,000 | 0 | 0 | 0 | 1,500 |
| Example 3 | | | | | | | | | | | |
| Comparative | W1 | 15,000 | 15,000 | 0 | 0 | 0 | 15,000 | 15,000 | 0 | 0 | 0 |
| Example 4 | | | | | | | | | | | |

TABLE 2

| | Extracted Metal Ions | | | | | | | | | |
|---|---|---|---|---|---|---|---|---|---|---|
| | | Maximum | Water | pH | | Metal Extractant | | | | |
| | | Amount | Phase | during | Oil | | Molecular | | Mixing | Selection |
| No. | Kind | Extracted | pH | Mixing | Phase | | Weight | pKa | Amount | Ratio |
| Example 1 | Co, Ni | Co | 6.5 | 3.2 | Y1 | E-1 | 428 | 1.1 | 0.73 | 2.0 |
| Example 2 | Co, Ni | Co | 6.5 | 3.2 | Y2 | E-2 | 400 | 0.8 | 0.73 | 30 |
| Example 3 | Co, Ni | Co | 6.5 | 4.5 | Y3 | E-3 | 428 | 2.1 | 0.73 | 19 |
| Example 4 | Co, Ni | Co | 6.5 | 6.0 | Y4 | E-4 | 328 | 6.5 | 0.73 | 1.4 |
| Example 5 | Rh, Pd | Rh | 6.2 | 3.5 | Y2 | E-2 | 400 | 0.8 | 1.30 | 15 |
| Example 6 | Rh, Pd | Rh | 6.2 | 4.8 | Y3 | E-3 | 428 | 2.1 | 1.30 | 10 |
| Example 7 | Co, Ni | Co | 6.5 | 3.2 | Y5 | E-5 | 414 | 0.9 | 0.73 | 1.9 |
| Example 8 | Co, Ni | Co | 6.5 | 3.2 | Y6 | E-6 | 465 | 0.3 | 0.73 | 1.8 |
| Example 9 | Co, Ni | Co | 6.5 | 3.5 | Y8 | E-8 | 430 | 1.1 | 0.73 | 1.4 |
| Comparative | Co | Co | 6.5 | 5.7 | Yc1 | PC-88A | 306 | 4.6 | 0.73 | 100 |
| Example 1 | | | | | | | | | | |
| Comparative | Co | Co | 6.5 | 8.8 | Yc2 | VA-10 | 172 | 7.9 | 0.73 | 100 |
| Example 2 | | | | | | | | | | |
| Comparative | Co, Mn | Co | 6.5 | 8.8 | Y1 | E-1 | 428 | 1.1 | 0.70 | 1.0 |
| Example 3 | | | | | | | | | | |
| Comparative | None | None | 6.5 | 6.3 | Y7 | E-7 | 457 | None | 0.73 | — |
| Example 4 | | | | | | | | | | |

The following can be seen from a comparison result between “Metal Ion Concentration (ppm) in Water Phase before Extraction” and “Metal Ion Concentration (ppm) in Water Phase after Extraction” shown in Table 1.

In both of Comparative Examples 1 and 2 using PC-88A and VA-10 as acidic metal extractants in the related art in the separation recovery of metal ions from the water phase, only Co ions among the two kinds of different-group metal ions present in the metal ion-containing aqueous solution (W1) can be extracted to the oil phase. However, the recovery rates of the Co ions were 20% and 13% at most. In addition, Comparative Example 3 is an experiment example where Mn ions belonging to Group 7 and Co ions belonging to Group 9 were used as metal ions extracted and separated from the water phase. Even in a case where the acidic metal extractant E-1 according to the embodiment of the present invention is used, Co ions cannot be separated and recovered with high selectivity. Further, Comparative Example 4 is an experiment example where the metal extractant E-7 not including active hydrogen was used. Both of Co ions and nickel ions as two kinds of metal ions belonging to different groups cannot be extracted.

On the other hand, in Examples 1 to 9 where the acidic metal extractant according to the embodiment of the present invention was used, two or kinds of different-group metal ions in the specific metal ion group present in the metal ion-containing aqueous solution can be extracted to the oil phase. In addition, the metal ions extracted in the maximum amount (in Examples 1 to 4 and 7 to 9: Co ions, Examples 5 and 6: Rh ions) can be extracted from the water phase to the oil phase substantially in the entire amount with a high selection ratio with respect to the metal ions other than the metal ions extracted in the maximum amount.

In Examples 1 to 4 and 7 to 9, in particular, in Examples 2 and 3 having a selection ratio of 30 or 19, while extracting valuable metal elements, for example, both of cobalt ions and nickel ions important for manufacturing a lithium ion battery, Co ions among the same-period different-group metal ions having similar physical behaviors and similar chemical behaviors can be recovered with high selectivity and high recovery rate. This way, it is considered from a comparison between Comparative Examples and Examples that the acidic metal extractant according to the embodiment of the present invention has the specific function of being selectively coordinated to two or more kinds of metal ions belonging to different groups in the specific metal ion group belonging to Groups 9 and 10 of the fourth to sixth periods. As a result, it was finally found that one kind of metal ions among the metal ions belonging to Groups 9 and 10 that can be recovered from waste LiB or the like in the specific metal ion group can be separated and recovered with high selectivity and high recovery rate.

This way, the details of the reason why, while extracting two or more kinds of different-group metal ions in the specific metal ion group from the water phase to the oil phase, the acidic metal extractant according to the embodiment of the present invention can separate and recover one kind of metal ions with high selectivity and high recovery rate is not clear, but is presumed to be that a balance between stability of complex ions formed by the acidic metal extractant being coordinated to the metal ions (the number of members in a coordinating ring and distortion of the complex ions) and compatibility with the oil phase (easy movement (extraction) to the oil phase) is improved.

From the above results, it can be seen that, by stripping the oil phase obtained in each of Examples using a typical method and conditions, the metal ions can be separated and recovered to the oil phase simply with high selectivity and high recovery rate in a large recover amount without deterioration in high selectivity.

Incidentally, in the technique of recovering specific metal ions from the water phase including a plurality of metal ions, it is generally difficult to recover the specific metal ions with high selectivity and recovery rate, and in a case where high selectivity is maintained as in Comparative Examples 1 and 2, the recovery rate decreases. Therefore, in order to achieve a predetermined recovery rate, currently, it is required to perform the separation recovery operation multiple times. On the other hand, according to the present invention, using the simple method, one kind of metal ions among two kinds of different-group metal ions can be extracted from the water phase to the oil phase substantially in the entire amount with high selectivity. Therefore, in consideration of the current conditions, the technical significance of the present invention is high from the viewpoint that, through the stripping step or the like from the obtained oil phase, one kind of metal ions can be recovered simply and with a small number of steps while further improving selectivity with high recovery rate.

The present invention has been described using the embodiments. However, unless specified otherwise, any of the details of the above description is not intended to limit the present invention and can be construed in a broad sense within a range not departing from the concept and scope of the present invention disclosed in the accompanying claims.

What is claimed is:

1. A separation recovery method of metal ions, the separation recovery method comprising:
extracting and separating two or more kinds of metal ions belonging to different groups by mixing a water phase and an oil phase with each other, the water phase including two or more kinds of metal ions belonging to different groups among metal ions belonging to Groups 9 and 10 of the fourth to sixth periods in a periodic table, and the oil phase including an acidic metal extractant having two or more coordinating functional groups selected from a group G1 of coordinating functional groups below,
<group G1 of coordinating functional groups>
a carboxy group, a phosphate group, a phosphonate group, a sulfonate group, and a sulfinate group.

2. The separation recovery method according to claim 1,
wherein the acidic metal extractant is a phosphate compound.

3. The separation recovery method according to claim 1,
wherein the acidic metal extractant is represented by Formula (I), 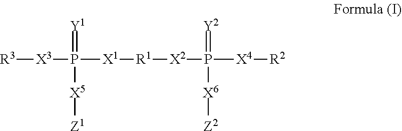
in Formula (I), R¹ represents an alkylene group, an alkenylene group, or an alkynylene group, which is substituted or unsubstituted,
R² and R³ each independently represent an alkyl group, an alkenyl group, or an alkynyl group, which is substituted or unsubstituted,
X¹ to X⁶ each independently represent a single bond, —O—, —NH—, or —S—,
Y¹ and Y² each independently represent an oxygen atom or a sulfur atom,
Z¹ and Z² each independently represent a hydrogen atom or a hydrocarbon group, and
at least one of Z¹ or Z² represents a hydrogen atom.

4. The separation recovery method according to claim 3,
wherein R¹ represents an unsubstituted alkylene group.

5. The separation recovery method according to claim 1,
wherein the two or more kinds of metal ions belonging to different groups are cobalt ions and nickel ions.

6. The separation recovery method according to claim 5,
wherein the two or more kinds of metal ions belonging to different groups are a metal recovery from a waste battery.

7. An acidic metal extractant for extracting and separating two or more kinds of metal ions belonging to different groups among metal ions belonging to Groups 9 and 10 of the fourth to sixth periods in a periodic table in a wet extraction method,
wherein the acidic metal extractant has two or more coordinating functional groups selected from a carboxy group, a phosphate group, a phosphonate group, a sulfonate group, and a sulfinate group.

8. The acidic metal extractant according to claim 7,
wherein the two or more kinds of metal ions belonging to different groups are cobalt ions and nickel ions.

9. The acidic metal extractant according to claim 7, which is represented by Formula (I), 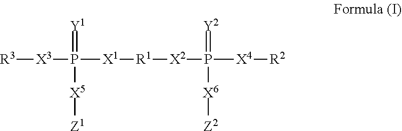
in Formula (I), R¹ represents an alkylene group, an alkenylene group, or an alkynylene group, which is substituted or unsubstituted,
R² and R³ each independently represent an alkyl group, an alkenyl group, or an alkynyl group, which is substituted or unsubstituted,
X¹ to X⁶ each independently represent a single bond, —O—, —NH—, or —S—,
Y¹ and Y² each independently represent an oxygen atom or a sulfur atom,
Z¹ and Z² each independently represent a hydrogen atom or a hydrocarbon group, and at least one of Z¹ or Z² represents a hydrogen atom.

10. The acidic metal extractant according to claim 9,
wherein R¹ represents an unsubstituted alkylene group.
